(19) United States
(12) Patent Application Publication
(10) Pub. No.: US 2019/0106088 A1
(43) Pub. Date: Apr. 11, 2019

(54) Quick battery exchange system for electric vehicles

(71) Applicant: Leonard Hayet, Weston, FL (US)

(72) Inventor: Leonard Hayet, Weston, FL (US)

(21) Appl. No.: 15/731,988

(22) Filed: Oct. 11, 2017

(51) Int. Cl. B60S 5/06; B60L 11/18; E04H 6/10; G06Q 20/10; G06Q 30/00

(52) U.S. Cl. CPC B60S 5/06; B60L 11/1822; B60K 1/04; G06Q 20/10; G06Q 30/012; E04H 6/10

(57) ABSTRACT

A system for quickly exchanging batteries, and their payment, in electric vehicles as they are battery powered vehicles (BPV). Includes requirement for all BPV to be constructed similarly for battery undercarriage horizontal slide insertion and removal, with electric and water socket plug-in connections in the undercarriage. Includes requirement that batteries are slab designed to be compatible in dimensions and weight for ease of exchanging batteries in BPV, with larger batteries for SUV's, trucks, busses. Includes, battery exchange multi lane building facilities for BPV to drive in, service personnel or robots to exchange batteries from plug-in charging racks with specially designed battery movement equipment, pay for their use, and BPV to drive away. Requires batteries, facilities, racks, equipment, and all data processing and its computers to be owned by investors, with initial battery, daily, and as-you-go, payments by BPV owners.

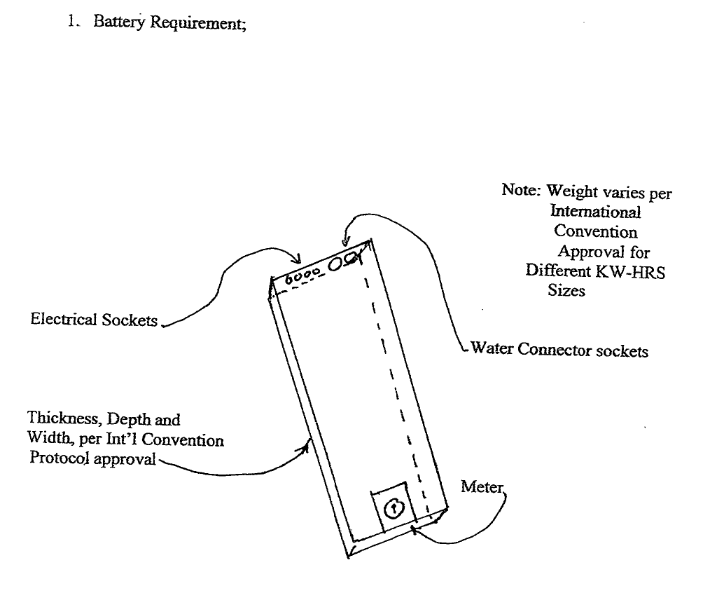

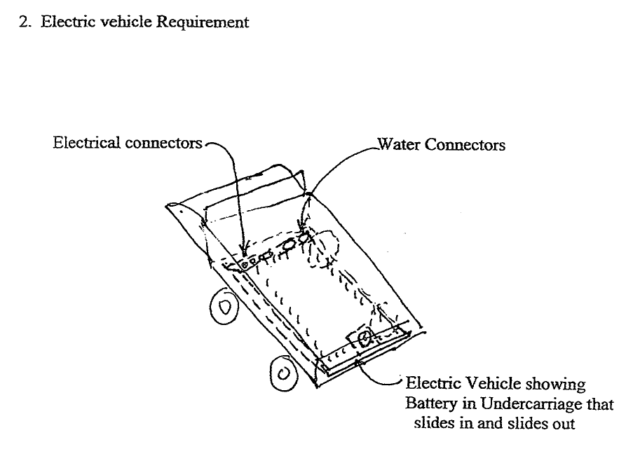

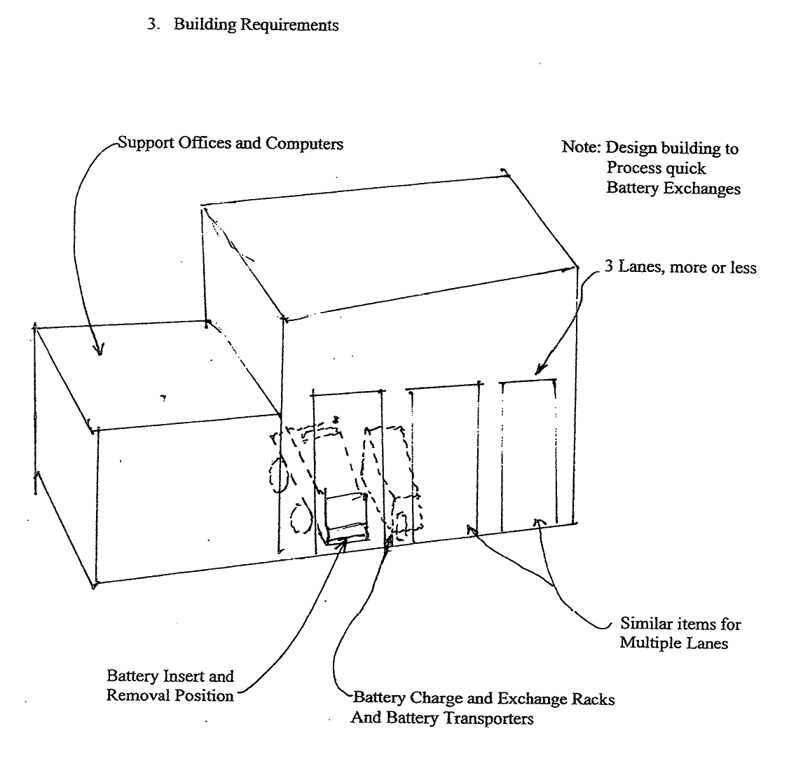

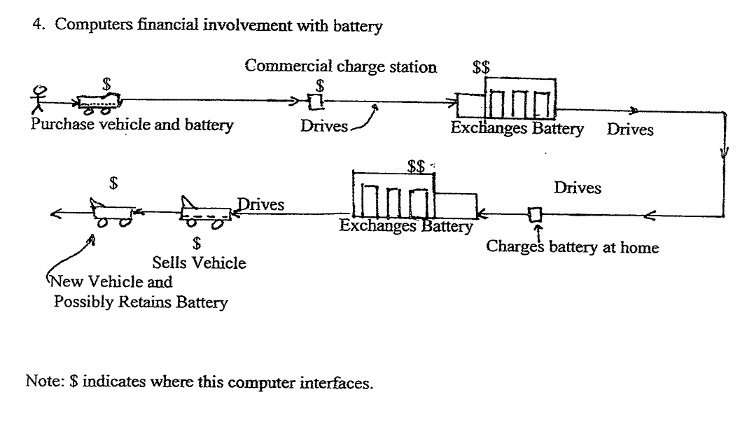

This is a System to provide for quick exchanges of batteries in electric vehicles, as they are battery powered vehicles (BPV). Typical specially designed battery exchange buildings, of various sizes, would be constructed with lanes to guide the electric vehicle to a prepositioned spot, and the vehicle, under its own power, stops at the prepositioned point. Adjacent to the electric vehicle position is a rack similar to a wide vertical ladder, in front view, with ball bearing sliders, deep enough to hold a number of horizontally placed batteries to be used to exchange the used up, or partially used up, battery in the electric vehicle with a newly charged battery.

The rack is a specially designed assembly to not only hold the batteries, but is a charging station for the several batteries, including quick disconnect electric charging sockets, but also cooling water circulating quick disconnects, that engage when the used batteries that are removed from the electric vehicles are pushed into the open spaces in the rack, for their reenergizing. Specially designed roller carriages are provided as the manually operated movement vehicles to be used to remove the used batteries from the electric vehicles, roll the used batteries to the rack, raise the used batteries to unused slots in the racks, and push them to their engage socket positions, for reenergizing. Then, the roller carriage is manually used to select a charged battery, pull it from its charged position, support it on the way to the open battery slide under carriage area in the electric vehicle, and push it into the rear roller bearing slides of the electric vehicle, into the sockets engage position. This manual system would be replaced by a robot operated automatic system, that would be developed for high use battery exchange buildings. The payment system used by the electric vehicle owner is that all batteries and battery exchange buildings, and support facilities, are owned by investors who are paid for the rental time of battery use, which data system for payment is determined at the time of purchase of the vehicle. If the vehicle owner desires, there could be no additional charges for battery change outs. Also, the daily use charge could have this amount predetermined. Financial dealings would be the basis of the financial cost of providing the battery and battery exchange buildings, and the services provided there. Several payment plans would be available, considering whether the user would have a multiple of battery change outs planned, or maybe he wants only one paid battery insertion at vehicle origination, and he would pay individually per battery change out. Therefore, the original cost of the electric vehicle to the buyer is less that of the battery, but the battery payment plan pays for the batteries use. The amount calculated could be a one time advance payment, or a payment plan; or another payment system to be individually determined. Battery discharge, energy recharge would be by home plug ins, or system owned commercial plug in spots, or at the service building, with cost paid by vehicle owner's credit card or home electric use, by how many hours of kilowatt-hours (KW-HRS) discharge show on the meter on the battery. The basis of this system is that all electric vehicles must be designed to have the roll in and roll out ability for this system's Approved battery and they will utilize this battery exchange plan. International Protocols must be developed to direct battery manufacturers to construct the same geometrically designed battery and to direct all electric vehicle manufacturers to comply with the ability to use the Approved battery. Then the battery exchange buildings will be constructed and the system will grow. Various sizes of entrys to the battery exchange buildings will be available, considering autos, SUV's, trucks, busses, etc., but the battery change out method will be similar to that described herein, even though various sizes of batteries will be developed for them, but the system will operate as described herein.

1. A system for quick exchanges of batteries in electric vehicles, as they are acting as battery powered vehicles(BPV); (1) the system includes that all BPV be constructed to allow slide in insertion and removal of batteries from the rear of the vehicle, into their undercarriage with electric and water socket plug in ability at the front of the vehicle; (2) slab constructed batteries geometrically and weight designed to slide into the BPV undercarriage with socket plug ins for electric and water at the front of the battery; (3) multi lane specially designed buildings for BPV to drive in and receive battery exchanges, with the buildings to include battery charging racks, battery movement equipment, and payment facilities; and (4) computer data processing ability to a central, or multi central, locations for individual accounts considering original battery purchase method, battery exchange payment plan, and pay as you go credit card, or otherwise, Kw-hrs payments.

2. System requirement for claim 1); an International Approval Convention must agree on Protocals that all BPV's be constructed with ability for approved batteries to be inserted, housed, connected, and be able to be withdrawn easily.

3. System requirement for claim 2); an International Approval Convention must agree on Protocols that all batteries be constructed at the geometric size and weight to be properly inserted, housed, with plug in ability for electric and water, and to be easily withdrawn from the approved BPV's. The battery must have electronic read out metering to indicate the KW-Hrs discharged during the BPV owners use, so required payment from the BPV owner can be calculated. The batteries are owned by investors, and financial agreements allow their use in the BPV.

4. System requirement for claim 3); buildings must be constructed to accept the BPV's requiring battery exchange. The buildings must be specially designed with multi lanes drive through ability, and with battery multiple charging racks, with battery movement equipment, and payment acceptance cubicles for specially trained personnel to process BPV owner payments.

5. System requirement for claim 4); there are four financial steps in the BPV use of the investor owned batteries that will be maintained by the data processing system, or systems; (a) when the battery is installed in the BPV at the BPV manufacturing plant, with agreement by the BPV owner as to its payment method, whether full payment, or extended payments, (b) if the BPV owner feels he will be driving multi distances, he could agree to a plan anticipating several battery exchanges will be needed, and he could agree to that in advance and eliminate future payments by his prior payment when he needs exchanges, say on a long trip, (c) the BPV owner could pay battery exchange fees when he needs a battery exchange, (d) when the old battery is exchanged, a payment will be required for the amount of KW-Hrs used up in the old battery. If the battery is charged at the BPV owner's house, or commercial facility, that cost will not appear at the battery exchange facility, as that cost will be paid for in other ways. An extensive array of computer data processing equipment, including central offices, and their operating personnel, will comprise the check and balance system for this practical, and financial, battery exchange system to originate and operate.
